(19) United States
(12) Patent Application Publication
(10) Pub. No.: US 2022/0242712 A1
(43) Pub. Date: Aug. 4, 2022

(54) REVERSE TELESCOPIC SYSTEM AND AUTOMATIC HANDLING EQUIPMENT

(71) Applicant: HANGZHOU EIOROBOT TECHNOLOGY CO., LTD., Zhejiang (CN)

(72) Inventor: Shuang SUN, Zhejiang (CN)

(73) Assignee: HANGZHOU EIOROBOT TECHNOLOGY CO., LTD., Zhejiang (CN)

(21) Appl. No.: 17/608,163

(22) PCT Filed: Apr. 7, 2020
(86) PCT No.: PCT/CN2020/083510

§ 371 Date: Nov. 2, 2021

(30) Foreign Application Priority Data
May 6, 2019 (CN) 201910373405.2

(51) Int. Cl. B66F 9/12

(52) U.S. Cl. CPC B66F 9/122

(57) ABSTRACT

A reverse telescopic system and an automatic handling equipment are provided. The reverse telescopic system includes a body structure, a fork arm structure, and a slide rail structure connecting the body structure and the fork arm structure. The body structure includes a main body, and a body driving structure mounted at a bottom portion of the main body, and the slide rail structure is connected to the main body. The fork arm structure includes a fork arm body slidably connected to the slide rail structure, and a fork arm driving structure mounted at a bottom portion of the fork arm body.

### BACKGROUND

### Technical Field

The invention relates to the technical field of automation equipment, in particular to a reverse telescopic system and automatic handling equipment.

### Description of Related Art

As a kind of automation equipment, a telescopic mechanism is often used to pick up, place and store goods. Typical telescopic mechanisms on the market include drawer guide rails, belt telescopic machines, electric push rods/pneumatic push rods/hydraulic push rods, telescopic fork mechanisms, etc. These telescopic mechanisms basically include a fixed body structure, a fork arm that can be stretched out and retracted to pick up goods, and a connecting slide rail connecting the two; the fork arm can be stretched and retracted through the connecting slide rail. Most of these mechanisms are only suitable for light loads, and are not practical for heavy loads or cases where the stretching distance is larger than the length of the fixed part.

At present, if such mechanism needs to be used under heavy load conditions (above 500 kg), the dead weight of the body structure will be increased in the design so as to increase the rigidity and strength of the body structure as much as possible and ensure that the body structure will not roll over when the fork arm is stretched out. If the weight of the body structure is not enough, other auxiliary means will be used: for example, the body structure is fixed on the ground using anchor bolts, or diagonal pull devices are added from other positions to fix the body structure, etc. This will increase the space occupied by the entire equipment, and make the equipment structure more complicated and inconvenient to move. Moreover, in order to ensure that the fork arm retracts smoothly, a high-power motor is also required to pull the fork arm back after the entire load by increasing the torque, thus putting forward high requirements for both the mechanism and energy.

The above content is only used to assist in the understanding of the technical scheme of this application, and does not mean that the above content is recognized as prior art.

### SUMMARY

Based on this, the invention provides a reverse telescopic system and automatic handling equipment, which can reduce the occupied space, simplify the mechanism, facilitate installation and movement, and greatly reduce the required power.

In order to achieve the above objective, the invention proposes the following technical scheme.

A reverse telescopic system includes a body structure, a fork arm structure, and a slide rail structure connecting the body structure and the fork arm structure; The body structure includes a main body, and a body driving structure mounted at a bottom portion of the main body, and the slide rail structure is connected to the main body. The fork arm structure includes a fork arm body slidably connected to the slide rail structure, and a fork arm driving structure mounted at a bottom portion of the fork arm body.

Alternatively, the slide rail structure includes the first slide rail, and the first slide rail is mounted on the main body. The fork arm structure includes the first fork arm body slidably connected to the first slide rail, and the fork arm driving structure is mounted at a bottom portion of the first fork arm body. Or, the slide rail structure includes the first slide rail and a second slide rail, and the first slide rail is mounted on the main body. The fork arm structure includes the first fork arm body slidably connected to the first slide rail, and a second fork arm body slidably connected to the second slide rail. The second slide rail is mounted on the first fork arm body, and the fork arm driving structure is mounted at a bottom portion of the second fork arm body.

Alternatively, the slide rail structure also includes a third slide rail, and the third slide rail is mounted on the second fork arm body. The fork arm structure includes a third fork arm body slidably connected to the third slide rail, and the fork arm driving structure is mounted at a bottom portion of the third fork arm body.

Alternatively, the first slide rail is slidably mounted on the main body; or/and, the second slide rail is slidably mounted on the first fork arm body.

Alternatively, the reverse telescopic system includes one set of the fork arm structure, and one corresponding set of the slide rail structure. The fork arm structure is slidably connected to the main body through the slide rail structure. Or, the reverse telescopic system includes at least two sets of the fork arm structures, and at least two sets of the corresponding slide rail structures, and each set of the fork arm structures is slidably connected to the main body through a set of slide rail structure.

Alternatively, the reverse telescopic system includes two sets of the fork arm structures mounted side by side, and two sets of the corresponding slide rail structures; the two sets of the slide rail structures are respectively connected to both sides of the main body, and each set of the fork arm structures is slidably connected to a set of the slide rail structure.

Alternatively, the fork arm driving structure includes at least one set of fork arm driving wheel mounted at the bottom portion of the fork arm body, and a driving wheel retracting structure connected to the fork arm driving wheel.

Alternatively, the driving wheel retracting structure includes a mounting plate mounted at the bottom portion of the fork arm body, a swing arm structure mounted on the mounting plate, and a push-pull rod structure connected between the swing arm structure and the mounting plate; the fork arm driving wheel is mounted at an end portion or a middle portion of the swing arm structure.

Alternatively, the body driving structure includes at least two sets of body driving wheels mounted at the bottom portion of the main body.

Alternatively, the fork arm structure further includes a lifting mechanism mounted on the fork arm body.

In addition, the invention further provides an automatic handling equipment, which includes an equipment body and the abovementioned reverse telescopic system mounted on the equipment body. When the fork arm structure of the reverse telescopic system stretches out, a length of the fork arm structure is greater than a length of the equipment body.

In the technical scheme proposed by the invention, the fork arm driving structure mounted under the fork arm body of the fork arm structure can drive the fork arm body to stretch out of the main body of the body structure through the slide rail structure. In this case, the main body can be kept stationary by keeping the body driving structure fixed, so as to achieve the purpose of stretching out the fork arm body to the goods position. After forking and picking up the goods using the fork arm body, the fork arm body can be kept stationary by keeping the fork arm driving structure stationary. In this case, the main body is driven by the body driving structure to move towards the direction of the fork arm body through the slide rail structure, so that the fork arm body is retracted relative to the main body and the purpose of reversely retracting the fork arm body is achieved. Thus, the fork arm body can be extended under no-load conditions and remain stationary under load conditions, but the normal stretching and retracting of the fork arm structure can still be realized, which is convenient for handling heavy loads. Compared with the traditional technology, the invention does not need to use anchor bolts or diagonal pulling devices to fix the body structure. Moreover, the invention does not need to use a high-power motor to drive, stretch and retract the fork arm structure, which can reduce the space occupied by the equipment, simplify the equipment structure, facilitate movement, save energy, and reduce the requirements for the equipment and greatly save costs.

### BRIEF DESCRIPTION OF THE DRAWINGS

In order to explain the embodiments of the invention or the technical scheme in the prior art more clearly, the drawings to be used in the description of the embodiments or the prior art will be briefly introduced below. Obviously, the drawings in the following description are only some embodiments of the invention. For a person of ordinary skill in the art, other drawings can be obtained from the structures shown in these drawings without creative work.

FIG. 1 is a schematic block diagram of the structure of a reverse telescopic system according to an embodiment of the invention;

FIG. 2 is a three-dimensional schematic diagram of the reverse telescopic system (when in a retracted state) according to an embodiment of the invention;

FIG. 3 is a three-dimensional schematic diagram of the reverse telescopic system (when in a stretched state) according to an embodiment of the invention;

FIG. 4 is a schematic diagram of the front view structure of FIG. 3;

FIG. 5 is a schematic diagram of the rear view structure of FIG. 3;

FIG. 6 is a front schematic diagram of a fork arm driving structure of the reverse telescopic system according to an embodiment of the invention;

FIG. 7 is a top schematic diagram of the fork arm driving structure of the reverse telescopic system according to an embodiment of the invention;

FIG. 8 is a left schematic diagram of the fork arm driving structure of the reverse telescopic system according to an embodiment of the invention;

FIG. 9 is a top schematic diagram of the reverse telescopic system (before handling goods) according to an embodiment of the invention;

FIG. 10 is a front schematic diagram of the reverse telescopic system (while handling goods and stretching out the fork arm structure) according to an embodiment of the invention;

FIG. 11 is a front schematic diagram of the reverse telescopic system (while handling goods and raising the lifting mechanism) according to an embodiment of the invention; and

FIG. 12 is a front schematic diagram of the reverse telescopic system (while handling goods and retracting the fork arm structure) according to an embodiment of the invention.

### DESCRIPTION OF THE TAG NUMBERS IN THE DRAWINGS

| Tag | |
|---|---|
| number | Name |
| 10 | Reverse telescopic system |
| 20 | Equipment body |
| 30 | Goods |
| 100 | Body structure |
| 110 | Main body |
| 120 | Body driving structure |
| 200 | Slide rail structure |
| 300 | Fork arm structure |
| 310 | Fork arm body |
| 320 | Fork arm driving structure |
| 322 | Mounting plate |
| 324 | Swing arm structure |
| 326 | Push-pull rod structure |
| 328 | Fork arm driving wheel |
| 330 | Lifting mechanism |

The realization of the purpose, functional characteristics and advantages of the invention will be further described in conjunction with the embodiments and with reference to the drawings.

### DESCRIPTION OF THE EMBODIMENTS

The technical schemes in the embodiments of the invention will be clearly and completely described below in conjunction with the drawings in the embodiments of the invention. Obviously, the described embodiments are only a part of the embodiments of the invention, rather than all the embodiments. All other embodiments obtained by a person of ordinary skill in the art based on the embodiments of the invention without creative work fall within the protection scope of the invention.

It should be noted that if there is a directional indication (such as up, down, left, right, front, back, top, bottom . . . ) involved in the embodiments of the invention, the directional indication is only used to explain the relative position relationship, movement, etc., between the components in a particular attitude (as shown in the drawings). If the particular attitude is changed, the directional indication changes accordingly.

In addition, if there is a description involving “first”, “second”, etc. involved in the embodiment of the invention, the description of “first”, “second”, etc. is used for a descriptive purpose only, and cannot be construed as indicating or implying its relative importance or implicitly specifying the number of technical features indicated. Thus, the feature qualified with “first” and “second” may explicitly or implicitly include at least one such feature. In addition, the technical schemes between the embodiments can be combined with each other, but only on the basis that the technical schemes can be achieved by a person of ordinary skill in the art. When the combination of technical schemes is contradictory or impossible, such combination of technical schemes shall be considered as not existing and not within the scope of protection claimed by the invention.

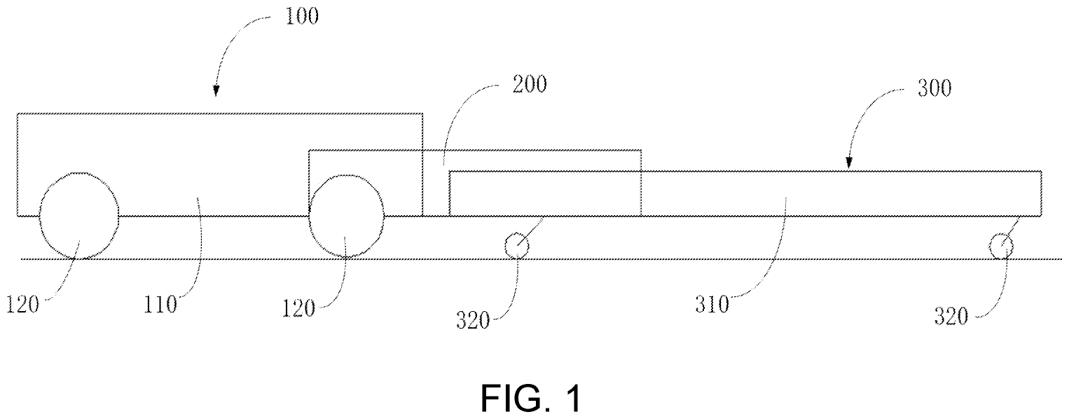

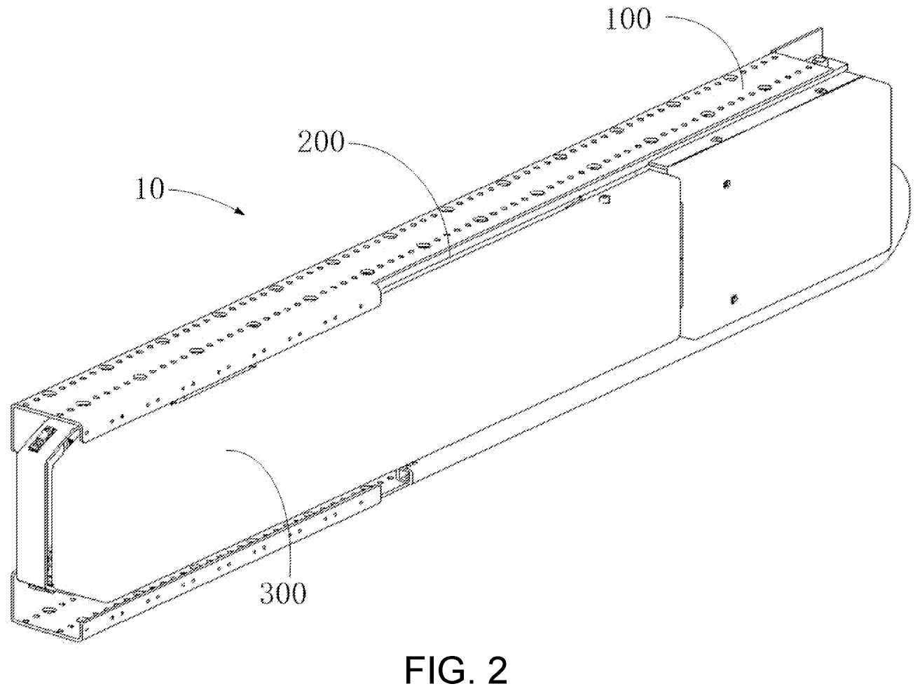

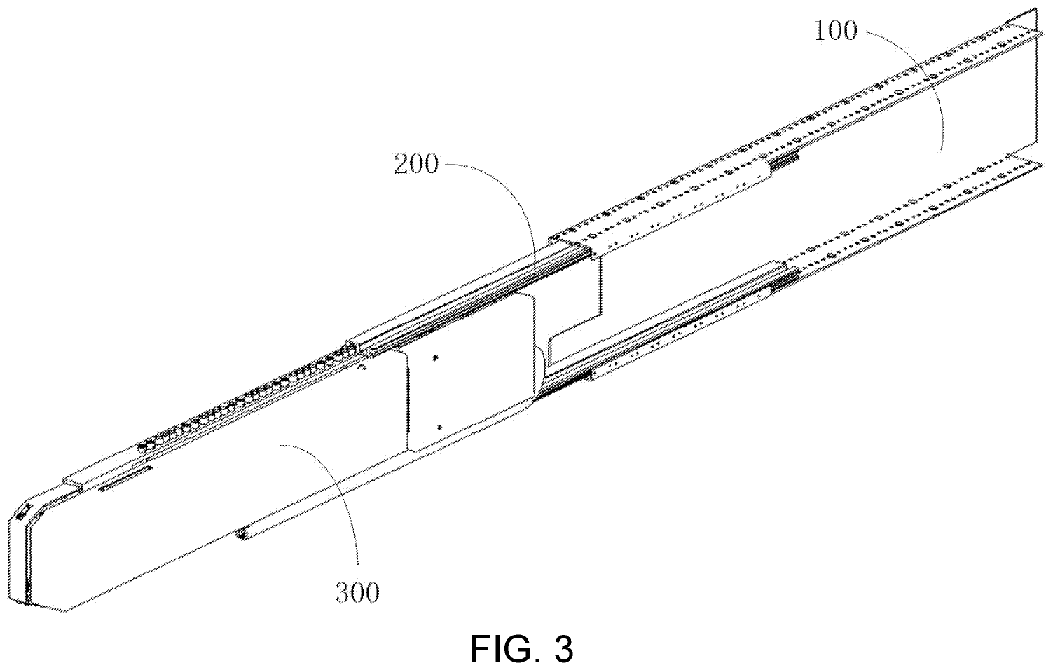

As shown in FIG. 1 to FIG. 3, the invention proposes a reverse telescopic system 10, which includes a body structure 100, a fork arm structure 300, and a slide rail structure 200 connecting the body structure 100 to the fork arm structure 300. The fork arm structure 300 can slide relative to the body structure 100 through the slide rail structure 200, so that the fork arm structure 300 can stretch out of the body structure 100 so as to fork the goods. The fork arm structure 300 can also slide in the opposite direction relative to the body structure 100, so that the fork arm structure 300 is retracted into the body structure 100 so as to move the goods.

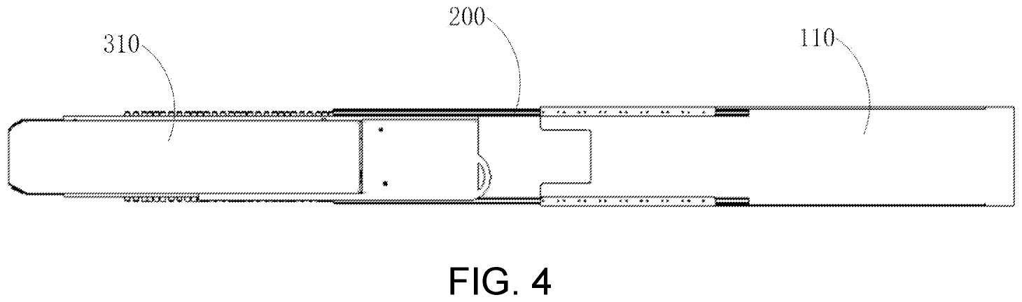

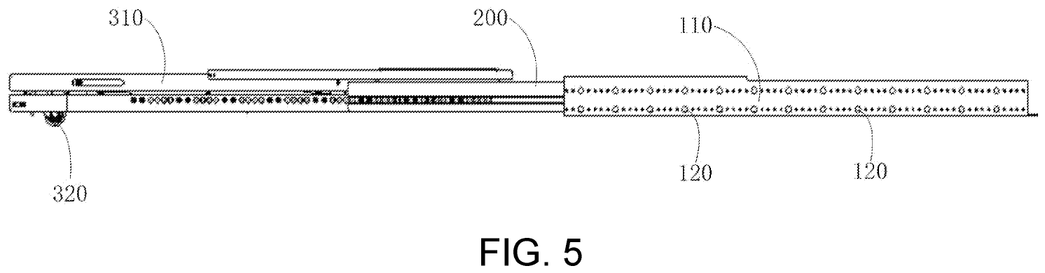

Specifically, as shown in FIG. 4 to FIG. 5, the body structure 100 can include a main body 110 and a body driving structure 120 mounted at the bottom portion of the main body 110. The slide rail structure 200 is connected to the main body 110. In addition, the fork arm structure 300 includes a fork arm body 310 slidably connected to the slide rail structure 200, and a fork arm driving structure 320 mounted at the bottom portion of the fork arm body 310. The fork arm driving structure 320 mounted under the fork arm body 310 of the fork arm structure 300 can drive the fork arm body 310 to stretch out of the main body 110 of the body structure 100 through the slide rail structure 200. In this case, the main body 110 can be kept stationary by keeping the body driving structure 120 fixed, so as to achieve the purpose of stretching out the fork arm body 310 to the goods position. After forking and picking up the goods using the fork arm body 310, the fork arm body 310 can be kept stationary by keeping the fork arm driving structure 320 stationary. In this case, the main body 110 is driven by the body driving structure 120 to move towards the direction of the fork arm body 310 through the slide rail structure 200, so that the fork arm body 310 is retracted relative to the main body 110 and the purpose of reversely retracting the fork arm body 310 is achieved. Thus, the fork arm body 310 can be extended under no-load conditions and remain stationary under load conditions, but the normal stretching and retracting of the fork arm structure 300 can still be realized, which is convenient for handling heavy loads. Compared with the traditional technology, the invention does not need to use anchor bolts or diagonal pulling devices to fix the body structure. Moreover, the invention does not need to use a high-power motor to drive, stretch and retract the fork arm structure, which can reduce the space occupied by the equipment, simplify the equipment structure, facilitate movement, save energy, and reduce the requirements for the equipment and greatly save costs.

In addition, in an embodiment, the reverse telescopic system 10 may include a set of fork arm structure 300 and a set of corresponding slide rail structure 200, and the set of fork arm structure 300 is slidably connected to the main body 110 through the set of slide rail structure 200. That is, in this embodiment, goods can be forked through a set of fork arm structure.

Moreover, in another embodiment, the reverse telescopic system 10 may include at least two sets of fork arm structures 300 and at least two sets of corresponding slide rail structures 200, and each set of fork arm structure 300 is slidably connected to the main body 110 through a set of slide rail structure 200. That is, in this embodiment, multiple sets of fork arm structures can be set at the same time to fork and pick up goods, which can adapt to goods of different shapes, sizes and weights.

Specifically, in this embodiment, the reverse telescopic system 10 may include two sets of fork arm structures 300 mounted side by side, and two sets of corresponding slide rail structures 200. The two sets of slide rail structures 200 are respectively connected to both sides of the main body 110, and each set of fork arm structures is slidably connected to one set of slide rail structure 200. That is, in this embodiment, two sets of fork arm structures can be mounted on the body structure, and the goods can be forked and picked up from both sides, thus the structure is simple, the force is uniform and stable, and the goods can be forked and picked up stably and reliably. Moreover, the two sets of fork arm structures and the two sets of slide rail structures can be symmetrically mounted on both sides of the main body relative to the center line of the main body. In addition, the number of sets of fork arm structures and slide rail structures can be set according to actual needs to meet different usage requirements.

Furthermore, in an embodiment, the fork arm structure 300 can be a single-stage fork arm structure; that is, after the fork arm structure 300 of the reverse telescopic system 10 is fully stretched out of the body structure, the fork arm structure cannot be additionally telescoped. That is, the fork arm structure 300 only includes a first fork arm body and a fork arm driving structure 320 mounted at the bottom portion of the first fork arm body. The slide rail structure 200 only includes a first slide rail connected to the main body 110, and the first slide rail is slidably connected to the first fork arm body. The first fork arm body can be stretched out of the main body 110 through the first slide rail under the action of the fork arm driving structure 320. The first fork arm body can also be retracted into the main body 110 through the first slide rail under the action of the body driving structure 120. In addition, the first slide rail can be slidably mounted on the main body; that is, the first slide rail can also be stretched out of the main body 110 or retracted into the main body 110, so that the stretching length of the first fork arm body can be greater than the length of the main body 110.

In addition, in another embodiment, the fork arm structure 300 can be a multi-stage fork arm structure, and the slide rail structure 200 can be a corresponding multi-stage slide rail structure. That is, after the fork arm structure 300 of the reverse telescopic system 10 is fully stretched out of the body structure 100, the fork arm structure 300 itself can be stretched outward again or multiple times, and can be telescoped by an extra length, so that the position of the stretching length of the fork arm structure 300 can be flexibly adjusted, and the stretching length can be greater than the length of the body structure 100. Moreover, due to the smaller load bearing force on the slide rail structure 200, the design of the multi-stage slide rail and the multi-stage fork arm can realize the multi-stage telescopic function and reduce the space occupied by the entire mechanism while ensuring the stretching length and achieving the miniaturization of the mechanism.

Specifically, the slide rail structure 200 may include a first slide rail and a second slide rail, and the first slide rail is mounted on the main body 110. The fork arm structure 300 may include a first fork arm body slidably connected to the first slide rail, and a second fork arm body slidably connected to the second slide rail. The second slide rail is mounted on the first fork arm body, and the fork arm driving structure 320 is mounted at the bottom portion of the second fork arm body. In this case, the reverse telescopic system can be set as a two-stage slide rail and two-stage fork arm structure, which can achieve stretching and retracting twice. The second fork arm body can be stretched out of the main body 110 through the second slide rail under the action of the fork arm driving structure 320, and then continue to stretch outward, and the first fork arm body can be stretched out of the main body 110 through the first slide rail, so that the entire fork arm structure 300 is stretched out of the main body 110; or under the action of the body driving structure 120, the first fork arm body can also be firstly retracted into the main body 110 through the first slide rail, and then the second fork arm body can be retracted into the main body 110 through the second slide rail. In addition, the fork arm driving structure 320 can also be mounted at the bottom portion of the first fork arm body, that is, the fork arm driving structure 320 can be mounted at the bottom portion of the first fork arm body and the bottom portion of the second fork arm body at the same time, thus the first fork arm body can be stretched out first, and the second fork arm body can then be stretched out, and the second fork arm body can be retracted first, and the first fork arm body can then be retracted. In addition, the first slide rail can be slidably mounted on the main body, or/and the second slide rail can be mounted on the first fork arm body; that is, the first slide rail can also stretch out of the main body 110 or retract into the main body 110, and the second slide rail can also stretch out of the first fork arm body or retract into the first fork arm body (that is, the second slide rail can slide alone, and can also slide on the basis of the sliding of the first slide rail), such that the sum of the stretching length of the first fork arm body and the stretching length of the second fork arm body can be greater than the length of the main body 110.

In addition, the reverse telescopic system 10 can be set as a three-stage slide rail and three-stage fork arm structure, which can achieve stretching and retracting three times. That is, the slide rail structure also includes a third slide rail in addition to the first slide rail and the second slide rail, and the third slide rail is mounted on the second fork arm body. In addition to including the first fork arm body and the second fork arm body, the fork arm structure further includes a third fork arm body slidably connected to the third slide rai. A fork arm driving structure is mounted at the bottom portion of the third fork arm body. The working principle is the same as that of the two-stage slide rail and two-stage fork arm structure, and is not be repeated here for brevity. In addition, the fork arm driving structure can also be mounted at the bottom portion of the first fork arm body and the second fork arm body, so that each fork arm body has independent telescopic capability. Moreover, the third slide rail can be mounted on the second fork arm body; that is, the third slide rail can also stretch out of the second fork arm body or retract into the second fork arm body (that is, the third slide rail can slide alone, and can also slide on the basis of the sliding of the first slide rail and/or the second slide rail), so that the sum of the stretching length of the first fork arm body, the second fork arm body and the third fork arm body can be greater than the length of the main body 110.

In addition, according to needs, the reverse telescopic system 10 can be set as a more-stage slide rail structure and a more-stage fork arm structure so as to achieve the required telescopic length.

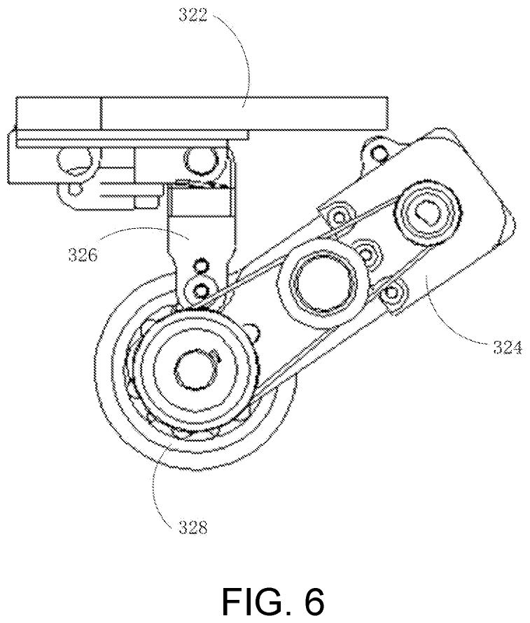

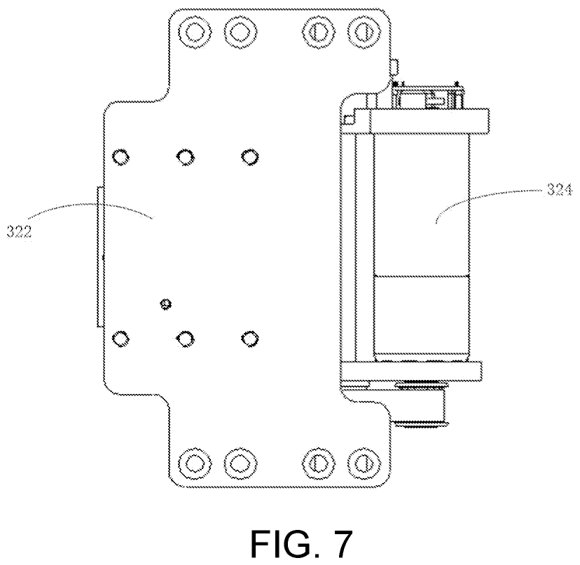

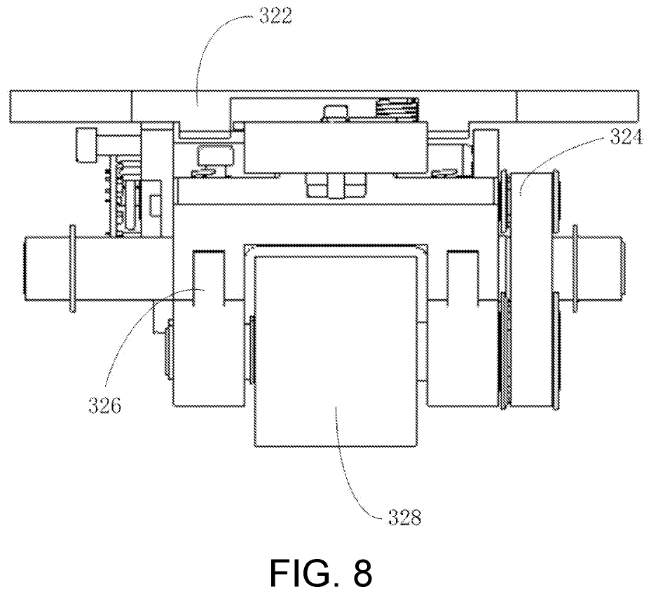

Furthermore, as shown in FIG. 6 to FIG. 8, the fork arm driving structure 320 may include at least one set of fork arm driving wheel 328 mounted at the bottom portion of the fork arm body 310, and a driving wheel retracting structure connected to the fork arm driving wheel 328. That is, the fork arm driving structure 320 may include the fork arm driving wheel 328 and the driving wheel retracting structure mounted at the bottom portion of the first fork arm body, may include the fork arm driving wheel 328 and the driving wheel retracting structure mounted at the bottom portion of the second fork arm body, and may include the fork arm driving wheel 328 and the driving wheel retracting structure mounted at the bottom portion of the third fork arm body. The fork arm driving wheel 328 at the bottom portion of the fork arm body 310 can drive the fork arm body 310 to move along the slide rail structure 200 and then stretch out of the body structure 100 or retract into the body structure 100. This enables the fork arm body 310 to stretch and retract freely in the main body 110 through the fork arm driving structure 320 while ensuring stable supporting of the fork arm body 310, and reducing the requirements for the slide rail structure 200 and the body structure 100 under the load condition of the fork arm body 310. Moreover, through the driving wheel retracting structure, the fork arm driving wheel 328 can be retracted into the fork arm body 310, so that the fork arm body 310 is conveniently retracted into the main body 110 or contained into the main body 110. That is, the fork arm driving wheel 328 at the bottom portion of the fork arm body 310 can be stretched and retracted up and down as needed. When the fork arm body 310 stretches out, the fork arm driving wheel 328 supports the ground. When the fork arm body 310 retracts, the fork arm driving wheel 328 is retracted into the fork arm body 310. The fork arm body 310 is retracted into the main body 110 through the slide rail structure 200. After the fork arm body 310 forks the goods, the fork arm body 310 is actively locked on the supporting surface through its own fork arm driving wheel 328, and then remains stationary; the body structure 100 starts to move towards the fork arm body through the slide rail structure 200 under the action of the body driving structure 120 until both the fork arm body 310 and the slide rail structure 200 are completely retracted into the main body.

Further, the driving wheel retracting structure may include a mounting plate 322 mounted at the bottom portion of the fork arm body 310, a swing arm structure 324 mounted on the mounting plate 322, and a push-pull rod structure 326 connected between the swing arm structure 324 and the mounting plate 322. The fork arm driving wheel 328 is mounted at the end portion or the middle portion of the swing arm structure 324. The swing arm structure 324 and the push-pull rod structure 326 can be installed at the bottom portion of the fork arm body 310 through the mounting plate 322. The swing arm structure 324 can be pushed and pulled through the push-pull rod structure 326, so that the swing arm structure 324 drives the fork arm driving wheel 328 to swing, and the fork arm driving wheel 328 can stretch from the inside of the fork arm body 310 to the outside of the bottom portion of the fork arm body 310 or retract from the outside of the fork arm body 310 into the fork arm body 310.

In addition, a set of fork arm driving structures 320 can be mounted at the outer end of the bottom portion of the fork arm body 310, two sets of fork arm driving structures 320 can also be respectively mounted at both ends of the bottom portion of the fork arm body 310, and three or more than three sets of fork arm driving structures 320 can be evenly mounted at the bottom portion of the fork arm body 310. Also, each set of the fork arm driving structures 320 may include at least two fork arm driving wheels 328, which are respectively mounted on both sides of the bottom portion of the fork arm body 310. In addition, a fork arm driven wheel structure can also be mounted at the bottom portion of the fork arm body 310, which can move together under the driving of the fork arm driving structure 320 and assists in movement and supporting.

Moreover, the body driving structure 120 may include at least two sets of body driving wheels mounted at the bottom portion of the main body 110. The at least two sets of the body driving wheels can be used to drive the main body 110 to move back and forth, so as to drive the main body 110 to move towards the fork arm body 310, or to drive the entire reverse telescopic system 10 to move. Each set of the body driving wheel may include at least a body driving wheel, that is, the body driving structure 120 may include two body driving wheels, or four body driving wheels, or six body driving wheels. In addition, a body driven wheel structure can also be mounted at the bottom portion of the main body 110, which can move together under the driving of the body driving structure 120 and assists in movement and supporting.

Moreover, the fork arm structure 300 may further include a lifting mechanism 330 mounted on the fork arm body 310. The lifting mechanism 330 can be raised or lowered to lift an object.

Furthermore, the invention proposes an automatic handling equipment, which includes an equipment body 20 and the reverse telescopic system 10 mounted on the equipment body 20, which can get and handle the goods 30 conveniently and simply. Moreover, when the fork arm structure of the reverse telescopic system is stretched out, the stretching length of the fork arm structure out of the equipment body can be greater than the length of the equipment body. For example, when the length of the equipment body is 1 m, the stretching length of the fork arm structure out of the equipment body can reach 1.5 m. Moreover, in this embodiment, the automatic handling equipment may include two sets of the reverse telescopic systems 10, and the two sets of the reverse telescopic systems 10 can be respectively mounted on both sides of the equipment body 20. According to needs, a set of the reverse telescopic system 10 or two or more sets of the reverse telescopic systems 10 can also be mounted on the equipment body. In addition, depending on the size of the pallet or goods, the reverse telescopic system can extend the fork arm structure to different lengths, which can improve work efficiency.

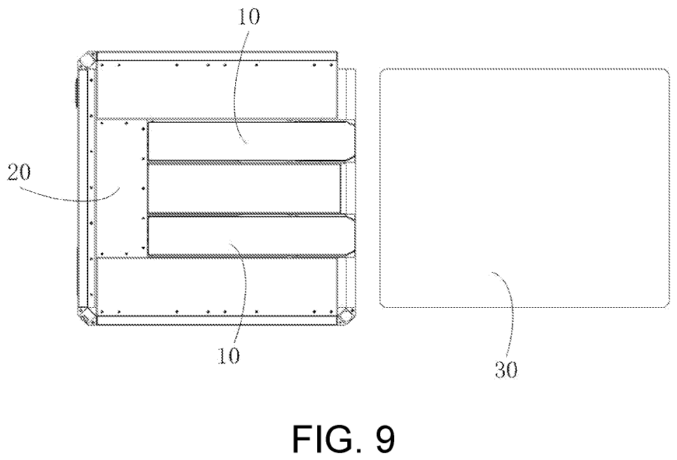

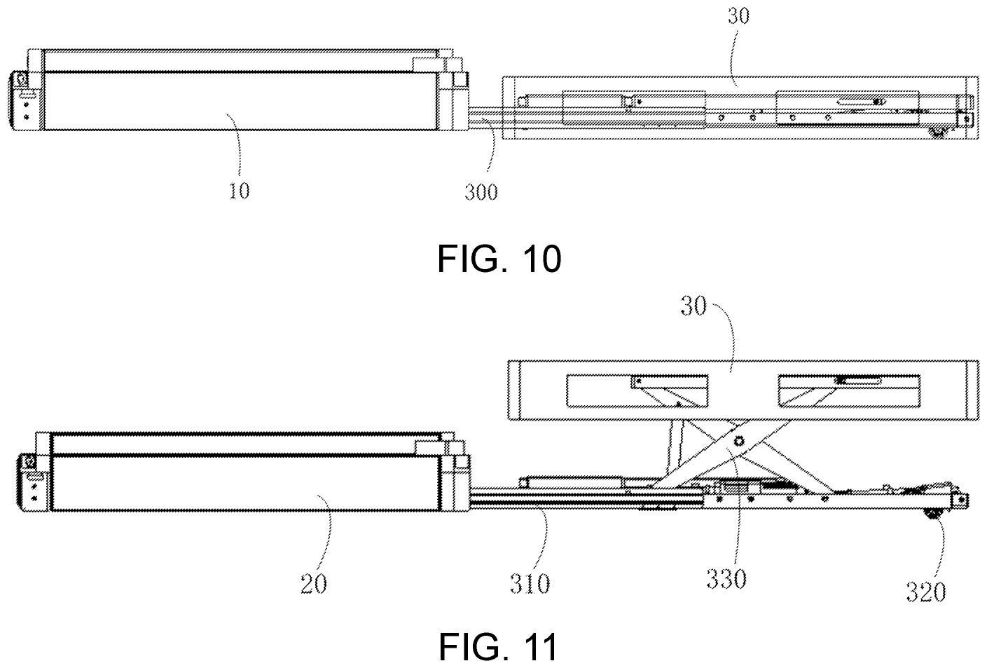

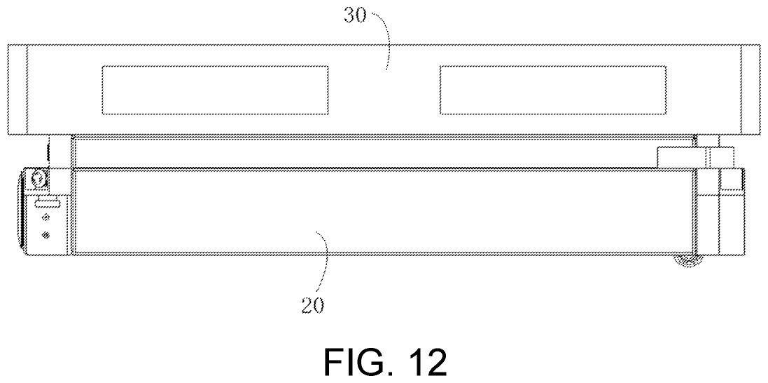

As shown in FIG. 9 to FIG. 12, in the process of getting the goods using the reverse telescopic system, the fork arm driving structure 320 mounted under the fork arm body 310 of the fork arm structure 300 can drive the fork arm body 310 to stretch out of the main body 110 of the body structure 100 through the slide rail structure 200. In this case, the main body 110 can be kept stationary by keeping the body driving structure 120 fixed, so as to achieve the purpose of stretching out the fork arm body 310 to the goods bottom position; then, the lifting mechanism 330 on the fork arm structure 300 located at the bottom of the goods is raised to lift the goods. After forking and picking up the goods using the fork arm body 310, the fork arm body 310 can be kept stationary by keeping the fork arm driving structure 320 stationary. In this case, the main body 110 (and the equipment body 20) are driven by the body driving structure 120 to move towards the fork arm body 310 through the slide rail structure 200, so that the fork arm body 310 is retracted relative to the main body 110 (and the equipment body 20) and the goods 30 lifted by the lifting mechanism 330 reach above the main body 110 (and the equipment body 20). Finally, the lifting mechanism 330 is lowered, and the goods 30 are placed on the main body 110 (or the equipment body 20) to get the goods 30. This can ensure that the reverse telescopic system does not bear a load during goods handling, and improve the service life and reliability of the mechanism.

In the technical scheme proposed by the invention, the reverse telescopic system can independently and actively run, and stretch out or retract by installing a fork arm driving device on the fork arm structure, so that the retracting mode of the reverse telescopic system is different from the existing one. In addition, the extended fork arm structure can remain stationary, so that the body structure can move towards the fork arm structure. The fork arm body of the fork arm structure can be extended under no-load conditions and remain stationary under load conditions, but the normal stretching and retracting of the fork arm structure can still be realized, which is convenient for handling heavy loads. Both the body structure and the fork arm structure have an active support (namely, the body driving structure and the fork arm driving structure), which can realize independent running back and forth. The support (i.e. the fork arm driving structure) of the fork arm structure can swing up and down. When the fork arm structure is retracted, the fork arm driving structure can swing and retract into the fork arm. The mechanism can be modularized. A mechanism can be used separately or multiple mechanisms can be used jointly so as to quickly increase the load-bearing capacity of the overall telescopic mechanism. Thus, the invention does not need to use anchor bolts or diagonal pulling devices to fix the body structure. Moreover, the invention does not need to use a high-power motor to drive, stretch and retract the fork arm structure, which can reduce the space occupied by the equipment, simplify the equipment structure, facilitate movement, save energy, reduce the requirements for the equipment and greatly save costs.

The above are only preferred embodiments of the invention, and do not limit the patent scope of the invention, as a result. All the equivalent structural transformations made by using the description of the invention and the content of the drawings under the invention concept or directly/indirectly applied in other related technical fields are included in the scope of patent protection of the invention.

1. A reverse telescopic system, comprising a body structure, a fork arm structure, and a slide rail structure connecting the body structure and the fork arm structure; wherein
the body structure comprises a main body, and a body driving structure mounted at a bottom portion of the main body, and the slide rail structure is connected to the main body; and
the fork arm structure comprises a fork arm body slidably connected to the slide rail structure, and a fork arm driving structure mounted at a bottom portion of the fork arm body.

2. The reverse telescopic system according to claim 1, wherein the slide rail structure comprises a first slide rail, and the first slide rail is mounted on the main body; the fork arm structure comprises a first fork arm body slidably connected to the first slide rail, and the fork arm driving structure is mounted at a bottom portion of the first fork arm body;
alternatively, the slide rail structure comprises the first slide rail and a second slide rail, and the first slide rail is mounted on the main body; the fork arm structure comprises the first fork arm body slidably connected to the first slide rail, and a second fork arm body slidably connected to the second slide rail; the second slide rail is mounted on the first fork arm body, and the fork arm driving structure is mounted at a bottom portion of the second fork arm body.

3. The reverse telescopic system according to claim 2, wherein the first slide rail is slidably mounted on the main body; or/and,
the second slide rail is slidably mounted on the first fork arm body.

4. The reverse telescopic system according to claim 1, wherein the reverse telescopic system comprises a set of the fork arm structure and a corresponding set of the slide rail structure, and the fork arm structure is slidably connected to the main body through the slide rail structure;
alternatively, the reverse telescopic system comprises at least two sets of the fork arm structures, and at least two sets of the corresponding slide rail structures, and each set of the fork arm structures is slidably connected to the main body through a set of the slide rail structure.

5. The reverse telescopic system according to claim 4, wherein the reverse telescopic system comprises two sets of the fork arm structures mounted side by side, and two sets of the corresponding slide rail structures; the two sets of the slide rail structures are respectively connected to both sides of the main body, and each set of the fork arm structures is slidably connected to a set of the slide rail structure.

6. The reverse telescopic system according to claim 1, wherein the fork arm driving structure comprises at least one set of fork arm driving wheel mounted at the bottom portion of the fork arm body, and a driving wheel retracting structure connected to the fork arm driving wheel.

7. The reverse telescopic system according to claim 6, wherein the driving wheel retracting structure comprises a mounting plate mounted at the bottom portion of the fork arm body, a swing arm structure mounted on the mounting plate, and a push-pull rod structure connected between the swing arm structure and the mounting plate; the fork arm driving wheel is mounted at an end portion or a middle portion of the swing arm structure.

8. The reverse telescopic system according to claim 1, wherein the body driving structure comprises at least two sets of body driving wheels mounted at the bottom portion of the main body.

9. The reverse telescopic system according to claim 1, wherein the fork arm structure further comprises a lifting mechanism mounted on the fork arm body.

10. An automatic handling equipment, comprising an equipment body and the reverse telescopic system mounted on the equipment body according to claim 1;
wherein when the fork arm structure of the reverse telescopic system stretches out, a length of the fork arm structure is greater than a length of the equipment body.
